(19) United States
(12) Patent Application Publication
(10) Pub. No.: US 2025/0196720 A1
(43) Pub. Date: Jun. 19, 2025

(54) METHOD FOR COMPONENT MONITORING FOR A VEHICLE, IN PARTICULAR A UTILITY VEHICLE, COMPUTER PROGRAM AND/OR COMPUTER-READABLE MEDIUM, CONTROL DEVICE AND VEHICLE

(71) Applicant: ZF CV Systems Global GmbH, Bern (CH)

(72) Inventor: Janik Ricke, Uetze (DE)

(21) Appl. No.: 19/064,381

(22) Filed: Feb. 26, 2025

Related U.S. Application Data
(63) Continuation of application No. PCT/EP2023/072992, filed on Aug. 22, 2023.

(30) Foreign Application Priority Data
Sep. 7, 2022 (DE) 10 2022 122 715.4

(51) Int. Cl. B60L 58/30; B60L 3/12

(52) U.S. Cl. CPC B60L 58/30; B60L 3/12

(57) ABSTRACT

A method for component monitoring for a vehicle, in particular a utility vehicle, having a fuel cell system including a turbomachine with a component, and a control device for controlling the turbomachine. The method includes: detecting sensor data relating to the component using a sensor device; ascertaining a comparison variable via the control device, taking into account the sensor data; comparing the sensor data with the comparison variable and ascertaining an event variable that can be characterized by the sensor data and that relates to the component on the basis of the comparison; and outputting the event variable depending on the event variable.

### CROSS-REFERENCE TO RELATED APPLICATIONS

This application is a continuation application of international patent application PCT/EP2023/072992, filed Aug. 22, 2023, designating the United States and claiming priority from German application 10 2022 122 715.4, filed Sep. 7, 2022, and the entire content of both applications is incorporated herein by reference.

### TECHNICAL FIELD

The disclosure relates to a method for component monitoring for a vehicle, in particular a utility vehicle, having a fuel cell system including a turbomachine with a component, and a control device for controlling the turbomachine. The disclosure also relates to a computer program and/or computer-readable medium, a control device for a vehicle, in particular a utility vehicle, for controlling a turbomachine of a fuel cell system, and a vehicle, in particular a utility vehicle, having a fuel cell system including a turbomachine, a sensor device and a control device.

### BACKGROUND

The monitoring of components of a vehicle, in particular a utility vehicle, is known from the prior art. By way of example, the monitoring procedure includes prompting data to be detected by a sensor, recorded, processed, evaluated and/or output. The monitoring procedure may be carried out by a control device of a vehicle, in particular a utility vehicle.

Furthermore, so-called fleet management systems (FMS) are known from the prior art. In these, data for monitoring a component are transmitted to an off-board server and evaluated and data are optionally transmitted from the server to the vehicle, in particular a utility vehicle. On the basis of the data, the state of the vehicle, in particular a utility vehicle, may be monitored and/or the operation of the vehicle, in particular a utility vehicle, may be regulated and/or improved.

Using a fleet management system, it is possible to make route planning dependent on wear assessment, on maintenance and/or repairs to the vehicle, in particular a utility vehicle.

U.S. Pat. No. 9,056,556 B1 discloses a system and a method for the management of an energy storage system for a vehicle. The energy storage system may include a battery system for a vehicle, for instance an electric vehicle or a hybrid electric vehicle. Vehicles may be in a group or fleet. The management system may be configured to use data and information which are available from data sources via a network or via instrumentation/sensors for vehicle systems. Data and information might be used in a system to manage the configuration and the operation of the energy storage system and the components, to manage/control the supply and the use/life-cycle of components and/or to be aggregated/analyzed in an analysis function for the system and the components. The predictive control of the battery system may be implemented by a management system using data sources outside the vehicle.

However, components of the vehicle, in particular a utility vehicle, may have different life-and/or maintenance-cycles and may react with different levels of sensitivity to influences that can be measured by sensors, which may influence the performance and/or the wear on the components.

In a vehicle, in a particular a utility vehicle, having a fuel cell system, the monitoring of a costly component of the fuel cell system may be important to a vehicle operator and/or fleet operator for reliable and economical operation of the vehicle, in particular a utility vehicle.

Fuel cell systems of this type are known from the prior art. In these fuel cell systems, a compressor is used to take in air, to compress it and to feed it to a cathode-side fuel cell input of the fuel cell for the purpose of carrying out the fuel cell reaction. The compressed mixture passes through the stack(s) of the fuel cell system. The mixture that remains after the abreaction exits a fuel cell output of the fuel cell arrangement on the cathode side as a gaseous fluid flow.

This fluid flow conventionally has an overpressure compared to the environment and is therefore used in the majority of fuel cell systems as a dynamic pressure to influence the reactant balance in the fuel cell arrangement and/or to drive an expander shaft of an expander. In the expander, the mixture exiting at the outlet side may be depressurized to ambient pressure and the energy released to the expander shaft is normally converted into electric energy when the expander is connected to a generator.

### SUMMARY

It is an object of the disclosure to provide an improved method for component monitoring. In particular, the disclosure may achieve the object of reliably, specifically and effectively monitoring a component of a fuel cell system.

The aforementioned object is achieved by various embodiments of the disclosure.

According to an embodiment of the disclosure, a method is proposed for component monitoring for a vehicle, in particular a utility vehicle, having a fuel cell system including a turbomachine with a component, and a control device for controlling the turbomachine. The method here includes: Detecting sensor data relating to the component using a sensor device; ascertaining a comparison variable via the control device, taking into account the sensor data; comparing the sensor data with the comparison variable and ascertaining an event variable that can be characterized by the sensor data and that relates to the component on the basis of the comparison; and outputting the event variable depending on the event variable.

The vehicle, in particular a utility vehicle, is referred to below as vehicle. It has been recognized here that a turbomachine, that is, a compressor and/or an expander, is a costly component of the fuel cell system and therefore the vehicle. The method therefore proposes specific monitoring of the turbomachine or the component of the turbomachine.

The sensor device may include a sensor of the turbomachine and/or a sensor of the vehicle. Sensor data, for example an electric current of power electronics, an electric voltage of the power electronics, the humidity and/or quantity of water in a stage of the turbomachine, the speed of a rotor, a coolant temperature, a pressure and/or a force on a bearing, may thus be detected. The sensor data here are representative of an actual state of the turbomachine monitored by the sensor device or of the component of the turbomachine and/or relevant variables for operating the flow machine. The actual state of the turbomachine may be characterized, for example, by the speed of the rotor of the turbomachine. The relevant variable for operating the turbomachine may be, for example, an ambient temperature and/or an acceleration acting on the turbomachine and/or a pressure acting on a bearing of the turbomachine. An influence on the operation and/or the wear of the turbomachine may be inferred from the sensor data.

For this purpose, the control device ascertains the comparison variable for comparing the comparison variable with the sensor variable. The comparison variable is a variable that characterizes the turbomachine and/or the operation thereof under predetermined conditions. The comparison variable corresponds, for example, to sensor data ascertained under normal conditions. The comparison variable can thus be compared with the sensor data. By way of example, the comparison variable and the sensor data each include a temperature, which temperatures can be compared with one another. The comparison variable is ascertained by the control device. For this purpose, the comparison variable is stored, for example, in the control device.

The event variable is ascertained through the comparison of the sensor data with the comparison variable. The event variable characterizes the comparison between the actual state of the component and the comparison variable, that is, a normal condition, for example. The event variable therefore gives an indication about an event that influences the component and/or the operation thereof and leads to a deviation between the actual state according to the sensor data and the comparison variable according to the predetermined condition, for example a normal operation. The event variable may include a difference between the comparison variable and the sensor data and/or it may depend on the difference.

The output of the event variable takes place depending on the event variable. It has been recognized here that not every possible event variable indicates a negative influence on the component. Therefore, not every possible event variable must be output.

The event variable may be used for the optimization of the operating strategy and/or for the maintenance of the turbomachine. At the same time, the specific output of a predetermined event variable provides a solution as to the efficiency with which the event variable may be output; for example, to enable the provided or desired event variables to be transmitted if there is little memory space and/or with a low data rate.

According to various embodiments, the method includes: Storing the event variable depending on the event variable. The event variables may therefore be stored before being output in order to output a plurality of event variables at the same time, for example as needed and/or if triggered by a query. The storage may also enable processing of the event variable, for example summing the event variables in order to enable a sum of the event variables to be output. By way of example, a total value may therefore be summed, which enables an estimation as to when maintenance is due.

According to various embodiments, the storage takes place depending on a first predetermined threshold condition relating to the event variable. It is thus enabled that the event variable is only output when the event variable contains relevant information. For example, the event variable may be compared with a threshold value defining the first threshold condition. If the event variable is greater than the threshold value, the first threshold condition is met and the event variable is stored. On the other hand, if the event variable is lower than the threshold value, the first threshold condition is not met and the event variable is not stored and is, for example, discarded. The threshold condition may be predetermined by the manufacturer of the turbomachine in order to characterize normal operation of the turbomachine.

According to various embodiments, the first predetermined threshold condition includes a first threshold value, wherein the first threshold value is selectable by the user. It is thus possible for a user of the turbomachine to optionally set the first threshold value within a predetermined range. The turbomachine may therefore be specifically adapted for the fuel cell system. As a result of the limitation imposed by the range, excessively rapid wear and/or damage to the turbomachine is avoided.

According to various embodiments, the event variable is discarded depending on a second predetermined threshold condition relating to the event variable. It is thus enabled that the event variable is only output when the event variable contains relevant information. For example, the event variable may be compared with a second threshold value defining the second threshold condition. If the event variable is smaller than the second threshold value, the second threshold condition is met and the event variable is discarded. On the other hand, if the event variable is greater than the second threshold value, the first threshold condition is not met and the event variable is not discarded; it is, for example, stored and/or processed further. The second threshold condition may be predetermined by the manufacturer of the turbomachine in order to characterize normal operation of the turbomachine. The second threshold value may be the same as the first threshold value.

According to various embodiments, the output takes place when a predetermined number of event variables has been stored. The output may then take place, for example, when a relevant number of event variables including relevant events has been ascertained. The number of event variables here may be output and/or optionally processed together. The number may be determined by a memory capacity of the control device, for example. A ring memory may therefore be used, which is configured to store the number of events. The output takes place when the number is reached. After the output, the ring memory may be cleared.

According to various embodiments, the method includes: Outputting a clearing signal for clearing the stored event variables. After the output, the stored event variables may therefore be cleared in order to free up the memory of the control device. By way of example, a ring memory can be realized in this way.

According to various embodiments, the output takes place on board the vehicle. In other words, the output takes place at an on-board component of the vehicle. Regulation of the turbomachine, the fuel cell system and/or the vehicle is thus possible in order to reduce further events with a negative influence on the turbomachine. In other words, it is possible to adapt the operating strategy of an overall system including the turbomachine. By way of example, a haulage company uses multiple utility vehicles with mutually different fuel cell systems. Furthermore, electric energy storage devices of the utility vehicles have different capacities, which may have a significant influence on the dynamics of the “utility vehicle” system. The fuel cell system is able to evaluate the system dynamics as critical or uncritical for the components of the turbomachine using the output from the control device. The fuel cell system may therefore be regulated so as to reduce the occurrence of critical system dynamics. An output by the on-board control device optionally takes place to provide information to a driver and/or user of the vehicle. Additionally or alternatively, the output takes place at an off-board server. The output may therefore take place at a fleet management system.

According to various embodiments, the event variable includes component information for identifying the component and/or regulating information for regulating the component. The event variable may include multiple pieces of information. The event variable may include information relating to the event or the comparison. If multiple components are monitored by the control device, the event variable advantageously includes the component information. Additionally or alternatively, the event variable includes regulating information in order to prompt the regulation of the turbomachine, the fuel cell system and/or the vehicle.

According to a further aspect of the disclosure, a computer program and/or computer-readable medium is provided. The computer program and/or computer-readable medium includes commands which, when the program or the commands are executed by a computer, prompt this latter to carry out the method described here and/or the steps of the method described here. The computer program and/or computer-readable medium may include commands to carry out steps of the method which are described as optional and/or advantageous in order to achieve a corresponding technical effect.

According to a further aspect of the disclosure, a control device for a vehicle, in particular a utility vehicle, is provided for controlling a turbomachine of a fuel cell system, which turbomachine includes a component. The control device is configured to carry out the method described here. The control device may be configured to carry out steps of the method which are described as optional and/or advantageous in order to achieve a corresponding technical effect. The control device may be a control device of the turbomachine. The control device may therefore be advantageously configured with regard to the turbomachine. In order to detect comprehensive information for operating the fuel cell system and to be able to advantageously regulate the fuel cell system, the control device may be a control device of the fuel cell system having the turbomachine. In order to detect comprehensive information for operating the vehicle and to be able to advantageously regulate the vehicle, the control device may be a control device of the vehicle.

According to a further aspect of the disclosure, a vehicle, in particular a utility vehicle, is provided. The vehicle includes a fuel cell system including a turbomachine, a sensor device and the control device described here. The vehicle and/or the control device may be configured to carry out steps of the method which are described as optional and/or advantageous in order to achieve a corresponding technical effect.

### BRIEF DESCRIPTION OF DRAWINGS

The invention will now be described with reference to the drawings wherein:

FIG. 1 shows a schematic illustration of a vehicle, in particular a utility vehicle, according to an embodiment of the disclosure; and,

FIG. 2 shows a schematic illustration of a sequence of a method according to an embodiment of the disclosure.

### DETAILED DESCRIPTION

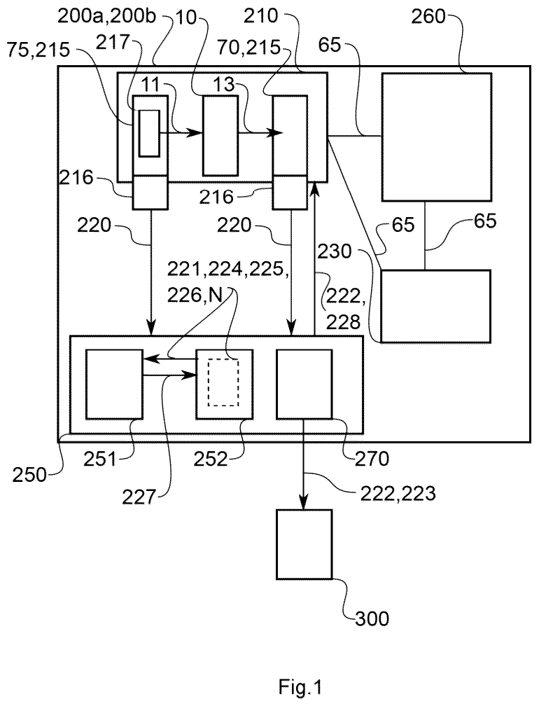

FIG. 1 shows a schematic illustration of a vehicle 200a, in particular a utility vehicle 200b, according to an embodiment of the disclosure,

The vehicle 200a, in particular a utility vehicle 200b, is referred to below as vehicle 200a, 200b. The vehicle 200a, 200b is, for example, a land vehicle or a water vehicle.

The vehicle 200a, 200b includes a fuel cell system 201, an energy storage device 260 and an electric drive 130. The fuel cell system 201 is configured to provide the energy storage device 260 with electric energy 65. The energy storage device 260 is, for example, a rechargeable energy storage device 260 and serves as a buffer battery for buffering electric energy 65. The energy storage device 260 is connected to the electric drive 230 in order to supply the electric drive 230 with electric energy 65 so that the electric drive 230 may drive the vehicle 200a, 200b. Additionally, the fuel cell system 210 is connected to the electric drive 230 to directly provide electric energy 65.

The fuel cell system 210 includes two turbomachines 215 and a fuel cell 10 having a cathode-side fuel cell input 11 and a cathode-side fuel cell output 13. One turbomachine 215 is configured as a compressor 75 and is connected to the fuel cell input 11 in a fluid-conducting manner to supply air to the fuel cell system 10. Another turbomachine 50 is configured as an expander 70 and is connected to the fuel cell output 13 in a fluid-conducting manner to discharge an exhaust gas flow of the fuel cell system 10.

The compressor 75 includes a component 217 of the turbomachine 215. The component 75 is, for example, a rotatably mounted impeller, a cooling arrangement, a bearing for supporting a shaft and/or power electronics, or an inverter. A component 217 of this type also includes the expander 70 (not shown).

To monitor the component 217, a sensor device 216 is provided. The sensor device 216 here may be a sensor device 216 of the respective turbomachine 215 of the fuel cell system 210 and/or of the vehicle 200a, 200b. The sensor device 216 may be a combination of vehicle sensors and, for example, compressor sensors. The sensor device 216 is configured to detect the sensor data 220 relating to the component 217. Sensor data 200 are, for example, an electric current of power electronics, an electric voltage of the power electronics, the humidity and/or quantity of water in a stage of one of the turbomachines 215, the speed of a rotor, a coolant temperature, a pressure and/or a force on a bearing. In an embodiment which is not shown, the sensor device 216 includes multiple and optionally different sensors in order to monitor multiple components 270.

To evaluate the sensor data 220, a control device 250 is provided according to FIG. 1. The control device 250 includes a processor 251 for processing information, a memory 252 for storing information and a communication device 270. The control device 250 may be a control device 250 of the respective turbomachine 215 and/or of the vehicle 200a, 200b (not shown). In the embodiment shown, the control device 250 is a control device 250 of the fuel cell system 210 and is configured to transmit regulating information 228 to the fuel cell system 210.

The control device 250 is configured to receive and evaluate the sensor data 220. In particular, a comparison variable 221 for comparing 130 the sensor data 220 with the comparison variable 221 is stored in the memory 252. The comparison variable 221 is stored, in particular, in a table-a so-called look-up table-in the memory 252. On the basis of the sensor data 220, the processor 251 retrieves a corresponding comparison variable in order to ascertain an event variable 222 that can be characterized by the sensor data 220 and that relates to the component 217 from the comparison 130. To ascertain 130′ the event variable 22, the control device 250 compares the comparison variable 221 with the sensor data 220. The event variable here includes, for example, a difference between the comparison variable 221 and the sensor data 220 and/or an indicator. For example, the indicator may indicate a deviation between the comparison variable 221 and the sensor data 220.

The event variable 222 is stored (not shown) depending on the event variable 222. For this purpose, a first threshold condition 224 with a first threshold value 226 defining the threshold condition 226 and, analogously, a second threshold condition 225 are stored in the memory 252. The storage 136 takes place here when the event variable 22 meets the first predetermined threshold condition 224. The event variable 222 is discarded when the event variable 222 meets a second predetermined threshold condition 225. Additionally, one or more further threshold conditions and/or threshold values may be defined by a user input and/or entry in order to store and/or discard the event variable 222. The stored event variables 222 may be processed and output, wherein, after the output, the stored event variables 222 may be cleared in order to free up memory capacity and to enable the storage of further event variables 222 (ring memory). The user, a vehicle operator and/or a fleet operator may thus specifically monitor events defined by the threshold conditions and/or threshold values.

For example, to enable the provision of a stop point for the state of the compressor 75, a service-life and/or time counter may be used for the power electronics. In a new compressor 75, the service life starts at 1 and reduces according to the output of the events which are stored in the memory 252, that is, when the first threshold condition 224 is met. That is, an event variable 222 of 1 is initially stored for the power electronics. When the event variable 222 is stored, the counter subtracts the value by a predetermined value, for example, 0.02, which is representative of a reduction in the service life of the compressor 75, and the new counter is stored. This value may be read out either from the control device 250 in a workshop and/or from the external server 300 through a connection via the communication device 270. In order to be able to provide reliable information about the service life, this value is not rewritable and/or alterable. Even when the first threshold value 225 is determined by the user, the output takes place according to a threshold value 225 which is predetermined by the manufacturer.

The communication device 270 is configured to output the event variable 222 to an external server 300. For this purpose, the communication device 270 may be configured for communication via a wireless local network (WLAN) and/or via a mobile wireless network, in particular 4G (LTE) and/or 5G. The event variable 222 here includes component information 223 for identifying the component 217. The server 300 provides a fleet management system 217. The state of the component 217 may thus be monitored. In an embodiment which is not shown, the server 300 sends information for regulating purposes to the communication device 270.

In order to regulate the component 217, the communication device 270 is configured to output the event variable 222 containing regulating information 228 to the fuel cell system 210 on board the vehicle. The regulation of the component 217 may take place directly and/or indirectly here by setting operating parameters of the fuel cell system 210.

The processor 251 is configured to prompt a clearing signal 227 for clearing the stored event variables 222 from the memory 252. The memory 252 is therefore free to store further sensor data 220.

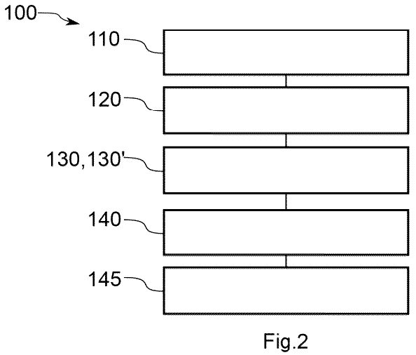

FIG. 2 shows a schematic illustration of a sequence of a method 100 according to an embodiment of the disclosure. The method 100 is a method 100 for component monitoring for a vehicle 200a, in particular a utility vehicle 200b, having a fuel cell system 210 including a turbomachine 215 with a component 217, and a control device 250 for controlling the turbomachine 215. A vehicle 200a, 200b of this type is described with reference to FIG. 1. FIG. 2 is described with reference to FIG. 1 and the description thereof.

The method 100 includes: Detecting 100 sensor data 220 relating to the component 217 of the turbomachine 215 using a sensor device 216.

The ascertainment 120 of a comparison variable 221 by the control device 250 takes place taking into account the sensor data 220.

A comparison 130 of the sensor data 220 with the comparison variable 221 takes place and the ascertainment 130′ of an event variable 222 that can be characterized by the sensor data 220 and that relates to the component 217 takes place on the basis of the comparison 130.

The storage 135 of the event variable 222 takes place depending on the event variable 222. The storage 135 takes place here when the event variable 222 meets a first predetermined threshold condition 224. The first predetermined threshold condition 224 includes a first threshold value 226, wherein the first threshold value 226 is selectable by the user. The event variable 222 is discarded when the event variable 222 meets a second predetermined threshold condition 225.

The output 140 of the event variable 222 takes place depending on the event variable 222. The output 140 takes place here when a predetermined number N of event variables 222 has been stored. The output 140 takes place on board the vehicle and/or at an off-board server 200.

The output 145 of the clearing signal 226 takes place to clear the stored event variables 222.

It is understood that the foregoing description is that of the preferred embodiments of the invention and that various changes and modifications may be made thereto without departing from the spirit and scope of the invention as defined in the appended claims.

### LIST OF REFERENCE SIGNS (PART OF THE DESCRIPTION)

10 Fuel cell
11 Fuel cell input
13 Fuel cell output
65 Electric current
70 Expander
75 Compressor
100 Method
110 Detection
120 Ascertainment of a comparison variable
130 Comparison
130′ Ascertainment of an event variable
140 Output of the event variable
145 Output of a clearing signal
200a Vehicle
200b Utility vehicle
210 Fuel cell system
215 Turbomachine
216 Sensor device
217 Component
220 Sensor data
221 Comparison variable
222 Negative event
223 Component information
224 First threshold condition
225 Second threshold condition
226 First threshold value
227 Clearing signal
228 Regulating information
250 Control device
251 Processor
252 Memory
230 Electric drive
260 Energy storage device
270 Communication device
300 Server
N Number

1. A method for component monitoring for a vehicle having a fuel cell system including a turbomachine with a component, and a control device for controlling the turbomachine, the method comprising:
detecting sensor data relating to the component via a sensor device;
determining a comparison variable via the control device, taking into account the sensor data;
comparing the sensor data with the comparison variable and determining an event variable characterizable by the sensor data and relating to the component on a basis of the comparison; and,
outputting the event variable depending on the event variable.

2. The method of claim 1 further comprising storing the event variable depending on the event variable.

3. The method of claim 2, wherein the storage takes place in dependence upon a first predetermined threshold condition relating to the event variable.

4. The method of claim 3, wherein the first predetermined threshold condition includes a first threshold value; and, the first threshold value is selectable by the user.

5. The method of claim 1, wherein the event variable is discarded in dependence upon a second predetermined threshold condition relating to the event variable.

6. The method of claim 2, wherein said outputting takes place when a predetermined number of event variables has been stored.

7. The method of claim 6 further comprising outputting a clearing signal to clear stored event variables.

8. The method of claim 1, wherein said outputting takes place at least one of: on board the vehicle and at an off-board server.

9. The method of claim 1, wherein the event variable includes component information for at least one of: identifying the component and regulating information for regulating the component.

10. The method of claim 1, wherein the vehicle is a utility vehicle.

11. A computer program stored on a non-transitory computer-readable medium, the computer program comprising commands configured, when executed by a processor, to perform the method of claim 1.

12. A non-transitory computer-readable medium comprising program code configured, when executed by a processor, to prompt the processor to perform the method of claim 1.

13. A control device for a vehicle, the control device being for controlling a turbomachine of a fuel cell system, the turbomachine having a component, the control device comprising:
a non-transitory computer readable medium having program code stored thereon;
a processor;
said program code being configured, when executed by said processor, to:
detect sensor data relating to the component via a sensor device;
determine a comparison variable taking into account the sensor data;
compare the sensor data with the comparison variable and determine an event variable characterizable by the sensor data and relating to the component on a basis of the comparison; and,
output the event variable depending on the event variable.

14. The control device of claim 13, wherein the vehicle is a utility vehicle.

15. A vehicle comprising:
a fuel cell system having a turbomachine;
said turbomachine including a component;
a sensor device;
a control device including a processor and a non-transitory computer readable medium having program code stored thereon;
said program code being configured, when executed by said processor, to:
detect sensor data relating to said component via said sensor device;
determine a comparison variable taking into account the sensor data;
compare the sensor data with the comparison variable and determine an event variable characterizable by the sensor data and relating to said component on a basis of the comparison; and,
output the event variable depending on the event variable.

16. The vehicle of claim 15, wherein the vehicle is a utility vehicle.
